(19) United States
(12) Patent Application Publication
(10) Pub. No.: US 2006/0039834 A1
(43) Pub. Date: Feb. 23, 2006

(54) Test tube rack having tag with reference to which data read and write operations can be performed by wireless communications

(75) Inventor: Teruaki Itoh, Kumamoto-shi (JP)

Correspondence Address: NIXON & VANDERHYE, PC, 901 NORTH GLEBE ROAD, 11TH FLOOR, ARLINGTON, VA, 22203, US

(73) Assignee: IDS Co., Ltd., Kumamoto (JP)

(21) Appl. No.: 11/201,093

(22) Filed: Aug. 11, 2005

(30) Foreign Application Priority Data
Aug. 23, 2004 (JP) 2004-242244

(51) Int. Cl. B01L 9/06

(52) U.S. Cl. 422/104; 211/74

(57) ABSTRACT

A test tube rack is provided with a rack main body and a noncontact tag. The rack main body is configured to hold a plurality of test tubes in which a sample is contained. The tag is provided on the rack main body. The tag stores data required for keeping the test tubes. The data can be written and read externally of the rack main body through the use of an antenna. The antenna performs wireless communications with the tag and is capable of transmitting and receiving data.

### CROSS-REFERENCE TO RELATED APPLICATIONS

This application is based upon and claims the benefit of priority from prior Japanese Patent Application No. 2004-242244, filed Aug. 23, 2004, the entire contents of which are incorporated herein by reference.

### BACKGROUND OF THE INVENTION

1. Field of the Invention

The present invention relates to a test tube rack which is used for keeping test tubes which contain a sample, such as blood, or for transporting the test tubes.

2. Description of the Related Art

A conventionally known test tube rack permit test tubes to be grouped and kept in units of a predetermined number in the state where they contain a sample such as blood. This type of test tube rack comprises a rack main body having a plurality of insertion holes in which test tubes are inserted. The information required for keeping or transporting the test tubes is displayed in the form of a bar code printed on a bar code label. The bar code lapel is pasted to the rack main body at a position which can be externally recognized.

The conventional test tube rack has problems in that the bar code printed on the bar code label has to be read by use of a bar code reader each time the information required for keeping or transporting the test tubes is referred to, and it takes time to refer to the information.

If a plurality of bar code labels are attached to a single rack main body, it is necessary to use bar code readers that are equal in number to the bar code labels. The cost of equipment is inevitably high.

Furthermore, new information, such as information representing the need for reexamination, cannot be additionally written on the bar code labels during the transportation of the test tube racks. In other words, the information required for keeping or transporting the test tubes is limited to the information that can be represented by the bar codes printed on the bar code labels.

### BRIEF SUMMARY OF THE INVENTION

An object of the present invention is to provide a test tube rack which enables data stored in a tag to be easily read out externally of the rack main body and which enables additional data to be written in the tag or read out therefrom.

To attain the above object, a test tube rack according to one embodiment of the present invention comprises: a rack main body configured to hold a plurality of test tubes in which a sample is contained; and a noncontact tag provided on the rack main body. The tag stores data required for keeping the test tubes. The data can be written and read externally of the rack main body through the use of an antenna. The antenna performs wireless communications with the tag and is capable of transmitting and receiving data.

With the above configuration, the data stored in the tag can be easily read out by performing communications with the tag externally of the rack main body. In addition, there is no need to prepare a plurality of bar code readers, as in the prior art. The cost of equipment is therefore low.

Furthermore, new data can be written in the tag when needed. This means that the data required for keeping the test tubes or for another purpose is not limited to the data that is stored in the tag beforehand. Reliable management of data is thus ensured.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view of a test tube rack that employs a wireless communication system according to one embodiment of the present invention; and

FIG. 2 is a schematic block diagram showing a noncontact tag used in the embodiment.

### DETAILED DESCRIPTION OF THE INVENTION

An embodiment of the present invention will now be described with reference to the accompanying drawings.

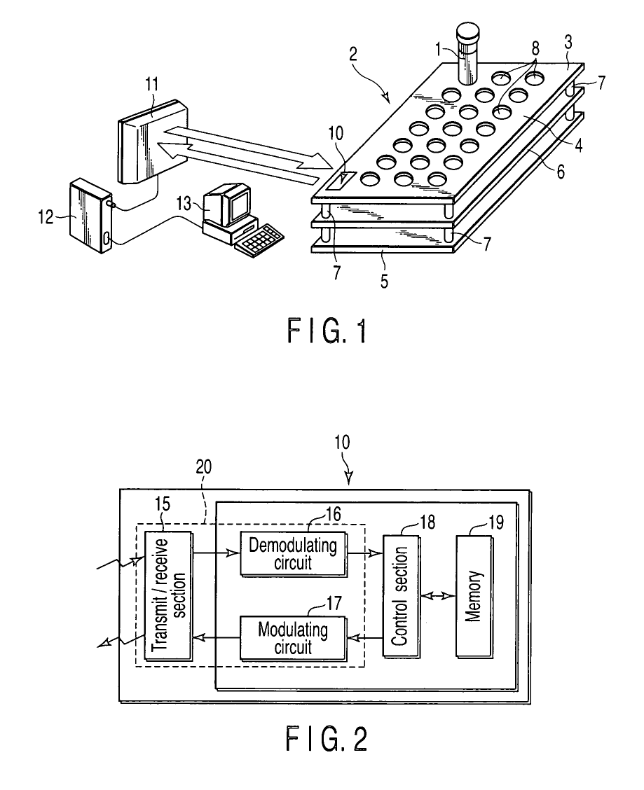

FIG. 1 shows a test tube rack 2 used for keeping or transporting a plurality of test tubes 1. The test tubes 1 contain a sample, such as blood or urine. The test tube rack 2 comprises a rack main body 3 configured to hold the test tubes 1 in such a manner that the test tubes 1 stand upright. The rack main body 3 includes a top plate 4, a bottom plate 5, an intermediate plate 6, and a plurality of supports 7. The top plate 4, the bottom plate 5 and the intermediate plate 6 are parallel to one another and are kept apart in the axial direction of the test tubes 1 placed in the test tube rack 2. The top plate 4, the bottom plate 5 and the intermediate plate 6 are coupled together by the supports 7.

The top plate 4 and the intermediate plate 6 have a plurality of insertion holes 8 in which the test tubes 1 are inserted. In the example shown in FIG. 1, the rack main body 3 has twenty-one insertion holes 8, but the number of insertion holes provided can be arbitrarily determined in accordance with the need. For example, the number of insertion holes is in the range of 5 to 1,000.

The test tubes 1 are inserted in the insertion holes 8, with their bottoms orientated downward. The test tubes 1 have their bottoms supported on the bottom plate 5 of the rack main body 3, and have their middle portions supported by the top plate 4 and the intermediate plate 6.

As shown in FIG. 1, an ID tag 10 is provided at a corner of the top plate 4 of the rack main body 3. The ID tag 10 stores data required for keeping or transporting the test tubes 1. In the case of the present embodiment, a rack ID number and a test result are stored in the ID tag 10 beforehand. The rack ID number is, for example, “₀₀₀₁”, and identifies the rack main body 3. The test result is, for example, a biochemical analysis result of a sample, such as a blood clotting result and a urinalysis result. The data stored in the ID tag 10 can be read out of the rack main body 3 or new data can be written in the ID tag 10 by means of an antenna 11. The antenna 11 is a transmit/receive type and performs wireless communications with the ID tag 10.

The antenna 11 is an example of a device that exchanges radio waves with reference to the ID tag 10. The antenna 11 is electrically connected to a computer 13 through an ID controller 12 (which is commonly referred to as a reader/writer). The ID controller 12 is an example of a device which controls communications between the ID tag 10 and the computer 13 and which performs protocol conversion between the ID tag 10 and a higher-level device.

The data additionally written in the ID tag 10 by wireless communications is, for example, data indicating whether or not reexamination of a sample is required. This data is supplied first to the computer 13, and then to the antenna 11 through the ID controller 12. The data is transmitted from the antenna 11 in the form of radio waves, and the ID tag 10 receives the radio waves transmitted from the antenna 11, whereby the data is written.

As shown in FIG. 2, the ID tag 10 includes a transmit/receive section 15, a demodulating circuit 16, modulating circuit 17, a control section 18 and a memory 19. The transmit/receive section 15 is made of an IC resonant circuit. The demodulating circuit 16 and the modulating circuit 17 are made of custom LSIs designed for special purposes. Each LSI includes a resin-molded chip and is resistant to chemicals and heat.

The transmit/receive section 15 receives signals transmitted from the antenna 11 and transmits signals having the same frequency as the received signals to the antenna 11. The demodulating circuit 16 demodulates the signals transmitted from the transmit/receive section 15 and uses the decoded signals as data representing the examination information on samples. The control section 18 writes the data output from the demodulating circuit 16 in the memory 19. The memory 19 retains data representing the examination information on samples, and is made of an EEPROM, for example.

The control section 18 reads data out of the memory 19 and supplies the readout data to the modulating circuit 17. The modulating circuit 17 converts the data obtained from the control section into pulse signals, and supplies the pulse signals to the transmit/receive section 15.

The transmit/receive section 15 transmits pulse signals to the antenna 11. The transmit/receive section 15 rectifies carrier-wave signals when the ID controller 12 is operating, and power is applied to the memory 19, the demodulating circuit 16 and modulating circuit 17.

The transmit/receive section 15, the demodulating circuit 16 and the modulating circuit 17 jointly constitute data transmission means 20. The data transmission means 20 receives data externally provided by electromagnetic coupling and supplies the received data to the control section 18. Under the control of the control section 18, the data transmission means 20 transmits the data read out from the memory 19 to a structural element outside of the ID tag 10 by use of electromagnetic waves.

As described above, the rack main body 3, which holds the test tubes 1, is provided with the ID tag 10 which stores data required for keeping or transporting the test tubes 1 and which is capable of wireless communications. The data stored in the ID tag 10 can be easily read by performing communications with the ID tag 10 through the use of the antenna 11.

Unlike the prior art, the present invention does not have to employ a plurality of bar code readers. This enables a low cost of equipment.

In addition, the data indicating whether or not a sample has to be reexamined, can be additionally written in the ID tag 10 where necessary. In other words, the data required for keeping or transporting the test tubes 1 is not limited to the data that is stored in the ID tag 10 beforehand. This contributes to reliable management of data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A test tube rack used for keeping a plurality of test tubes in which a sample is contained, said test tube rack comprising:
a rack main body configured to hold the test tubes; and
a noncontact tag provided on the rack main body and storing data required for keeping the test tubes, the data being written and read externally of the rack main body through an antenna by wireless communications performed with respect to the tag.

2. The test tube rack according to claim 1, wherein the data stored in the tag includes an identification number assigned to the rack main body and a test result of the sample contained in the test tubes, and data additionally written in the tag by the wireless communications between the tag and the antenna includes data indicating whether or not the sample has to be reexamined.
